(19) United States
(12) Patent Application Publication
(10) Pub. No.: US 2013/0303180 A1
(43) Pub. Date: Nov. 14, 2013

(54) Multi-Channel State Information Feedback with Cell-specific Adaptive Granularity

(71) Applicants: Xiaoyi Wang, Beijing (CN); Peter Skov, Beijing (CN); Deshan Miao, Beijing (CN)

(72) Inventors: Xiaoyi Wang, Beijing (CN); Peter Skov, Beijing (CN); Deshan Miao, Beijing (CN)

(73) Assignee: NOKIA SIEMENS NETWORKS OY, Espoo (FI)

(21) Appl. No.: 13/980,334

(22) PCT Filed: Jan. 18, 2011
(86) PCT No.: PCT/CN11/00072

§ 371 Date: Jul. 18, 2013

(51) Int. Cl. H04L 5/00

(52) U.S. Cl. CPC H04L 5/0057
USPC 455/450

(57) ABSTRACT

It is described a user equipment for a cellular communication network providing a plurality of cells, the user equipment including a receiver unit for receiving a first and second transmissions via a first and a second communication channel. The first communication channel uses a first cell and the second communication channel uses a different, second cell of said plurality of cells. A feedback unit is configured for providing a first and second channel state information feedback components for the respective communication channels with a separate, cell specific granularity. Further described is a base station of the cellular communication network.

### FIELD OF THE INVENTION

The present invention relates to the field of wireless communication networks and in particular to channel state information feedback in wireless communication networks.

### ART BACKGROUND

Channel state information, i.e. information about the state of a communication channel between a user equipment and a base station of a wireless communication network, offers the opportunity to increase data rates but has the disadvantage of a reduced overhead. In particular for coordinated multipoint transmission which is for example employed in LTE advanced (LTE=3GPP Long Term Evolution), inter-cell feedback is extensively discussed and is also a main technical requirement for coordinated multi-point transmission (CoMP). Under current CoMP studies, it is widely recognized that explicit feedback, i.e. the feedback of the eigenvector of the channel matrix can provide the best picture of channel state information of the communication channel from the base station (i.e. enhanced nodeB in the case of LTE advanced) to the user equipment (UE). However, explicit feedback is difficult to be quantized and therefore a huge overhead is needed. From a realistic system perspective, implicit feedback may be a better choice.

In CoMP data to be transmitted to a particular user equipment is pre-coded, sometimes referred to as joint pre-coding, and transmitted over at least two base stations so as to generate constructive interference at the particular UE, thereby improving data transmission. Usually, pre-coded data are transmitted from several base stations simultaneously to several user equipments. For effective joint pre-coding, channel information is of high importance. For example, cell-specific reference signals may be transmitted from the base stations to the user equipments, allowing the user equipments to estimate the downlink channels from the surrounding base stations. It has been proposed to feedback a pre-coding matrix index (PMI) in order to select the appropriate pre-coding of the data.

In view of the above-described situation, there exists a need for an improved technique that enables to provide an improved feedback of channel state information while substantially avoiding or at least reducing one or more of the above-identified problems.

### SUMMARY OF THE INVENTION

This need may be met by the subject-matter according to the independent claims. Advantageous embodiments of the herein disclosed subject-matter are described by the dependent claims.

According to a first aspect of the herein disclosed subject-matter, there is provided a user equipment for a cellular communication network providing a plurality of cells, the user equipment comprising a receiver unit for receiving a first transmission via a first communication channel and for receiving a second transmission via a second communication channel, the first communication channel using a first cell of said plurality of cells and the second communication channel using a second cell of said plurality of cells, the second cell being different from the first cell; a feedback unit configured for providing a first channel state information feedback component indicative of the state of the first communication channel and a second channel state information feedback component indicative of the state of the second communication channel; the feedback unit being further configured for providing each of the first channel state information feedback component and the second channel state information feedback component with a separate, cell specific granularity.

This aspect of the herein disclosed subject-matter is based on the idea that the feedback of channel state information is not equally useful for any base station from which the user equipment has received the transmission. For example, for base stations or cells which provide a very poor communication channel and hence a very low signal strength of the received transmission is considered as less important for coordinated multi-point transmission for a certain time. Contrary, if a base station or cell provides a very good communication channel and hence a high signal strength is obtained for the received transmission from the base station, this base station may be used for data transmission and hence an up-to-date channel state information is advantageous for improved data transmission schemes like coordinated multi-point transmission. For example, in a typical scenario one base station handles multiple cells and that CoMP operation is done among the cells operated by the same base station. The channel quality seen by one terminal towards different cells operated by the same base station can be quite different.

According to an embodiment, the cell specific granularity determined based on a signal strength with which the respective transmission using the cell is received by the receiver unit. For example, the cell specific granularity of the second cell may be determined based on the signal strength with which the second transmission is received by the receiver unit. Determination of the cell specific granularity may be performed by the user equipment or by another network entity of the cellular communication system, e.g. by a base station. If the cell specific granularity is determined by a network entity other than the user equipment, the cell specific granularity may be communicated to the user equipment by respective signaling. Determination of the cell specific granularity may be based on feedback information on the respective cell provided by the user equipment. In an embodiment, such feedback information on the respective cell (e.g. on the second cell) may include e.g. a power indication signal indicative of signal strength with which a transmission of the cell (e.g. the second transmission) is received by the receiver unit. In another embodiment, such feedback information on the respective cell may include one or more channel state information feedback components related to the respective cell which have been fed back by the user equipment previously.

According to an embodiment, a channel state information feedback component provided by the feedback unit is provided to the cell (and hence to the base station serving the cell) from which the respective transmission has been received. For example, in such an embodiment, the first channel state information feedback component is provided to the first cell and the second channel state information feedback component is provided to the second cell.

In other embodiments, a channel state information feedback component provided by the feedback unit is provided to the serving cell of the user equipment (and hence to the base station serving the serving cell). For example, if the first cell is the serving cell of the user equipment, in such an embodiment the first channel state information feedback component and the second channel state information feedback component are both provided to the first cell by the feedback unit.

Generally herein, the transmission from the base station may comprise or may consist of reference signals, for example cell-specific reference signals in case of a cellular communication network.

Generally herein, the term “channel state information feedback component” is to be interpreted broadly. In accordance with embodiments of the herein disclosed subject matter, this term embraces channel state information in any form or in any representation or any quantity derived from such channel state information.

Further generally herein, the “cell specific granularity” is also referred to as “granularity” for short.

In an embodiment, a serving cell is considered as a cell which is used by a control channel of the user equipment. A user equipment may have a single serving cell associated thereto or two or more serving cells.

According to an embodiment, the first channel state information feedback component is provided with a first granularity and the second channel state information feedback component is provided with a second granularity that is more coarse than the first granularity.

According to a further embodiment, the first communication channel is a serving communication channel and the first cell is a serving cell serving the user equipment with control signals.

Accordingly, in an embodiment, the receiver unit of the user equipment is configured for receiving the first transmission from a serving base station via the serving communication channel, wherein the serving base station serves the user equipment. Further in an embodiment, the second communication channel is also referred to as non-serving communication channel in the following uses a non-serving cell, which does not serve the user equipment at the instant of the reception of the transmission via the non-serving communication channel.

According to a further embodiment, the feedback unit is configured for providing a serving channel state information feedback component indicative of the state of the serving communication channel. For example, in an embodiment, the serving channel state information feedback component is provided to the serving base station in one embodiment. In a further embodiment, also the non-serving channel state information feedback component indicative of the state of the non-serving communication channel is fed back to the serving base station. In another embodiment, the non-serving channel state information feedback component is fed back to the non-serving base station. According to a further embodiment, channel state information feedback components are distributed among neighbouring base stations.

According to a further embodiment, the feedback unit is further configured for providing the serving channel state information feedback component independent of a signal strength with which the transmission of the serving cell (e.g. the first transmission) is received by the receiver unit. In other words, in a cellular communication system the channel state information of the serving cell is provided independent of the signal strength with which the further transmission is received by the receiver unit. According to an embodiment, the serving channel state information feedback component is provided with the highest granularity (also referred to as reference granularity), i.e. with the most detailed information.

According to embodiments of the herein disclosed subject matter, the term “granularity” relates to an information density. Hence in such embodiments, a higher granularity provides a higher information density, e.g. in the time domain, the spatial domain and/or in the frequency domain. Accordingly, in an embodiment, the cell specific granularity may also be referred to as a cell specific information density. According to a further embodiment, the granularity is defined as number of different states that the user equipment is able to indicate to the base station. Hence, coarse granularity corresponds to relatively few states that can be indicated to the base station and fine granularity corresponds to a relatively high number of states (generally more states than for coarse granularity) that can be indicated to the base station by the user equipment. Generally, coarse granularity provides less states that can be fed back to the base station than fine granularity.

According to an embodiment, the receiver unit is configured for receiving a granularity indicating signal from a base station of the cellular communication network, the granularity indicating signal setting the cell specific granularity of at least one of the first channel state information feedback component and the second channel state information feedback component.

According to an embodiment, the receiver unit is configured for providing a power indication signal indicative of a signal strength with which the second transmission is received by the receiver unit and the feedback unit is configured for providing the second channel state information feedback component with a granularity that depends on the power indication signal.

According to a further embodiment, only the non-serving channel state information feedback components, i.e. channel state information feedback components that are not related to a serving communication channel, may be provided with a granularity that depends on the power indication signal, while serving channel state information feedback components are provided with a granularity that is independent of the signal strength with the transmission from the serving base station is received by the receiver unit. In this regard, it should be understood that the term “providing the channel state information feedback component with a granularity that depends on the power indication signal” includes providing the channel state information feedback component with a granularity that depends on the signal strength with which the transmission from a base station, e.g. from the non-serving base station, is received by the receiver unit of the user equipment.

According to a further embodiment, the granularity of providing the channel state information feedback component of the non-serving communication channel, i.e. the granularity of inter-cell channel state information is more coarse for lower reception power. For example, the feedback unit may be configured for changing the granularity continuously or in a stepwise manner depending on the signal strength with which the transmission is received by the receiver unit.

According to a further embodiment and generally herein, the granularity is a granularity in at least one of time, frequency and space. In an embodiment, a certain granularity in space corresponds to a certain time resolution, e.g. by providing the feedback at certain time intervals which are the larger, the more coarse the granularity is. In another embodiment, a certain granularity in space corresponds to a certain spatial resolution to which the channels state information feedback component relates. In still another embodiment, a certain granularity in frequency corresponds to a certain frequency resolution to which the channels state information feedback component relates.

According to a further embodiment, the granularity is obtained by sub-sampling, i.e. by providing the granularity of a channel state information feedback component as a subset of a reference granularity. For example, in an embodiment, the feedback unit is configured for setting the granularity of at least one of the first and second channel state information components by sub-sampling, i.e. by providing the granularity of the respective channel state information feedback component as a subset of a reference granularity.

In a further embodiment, the reference granularity is the granularity of the serving channel state information feedback component. For example, in an embodiment the sub-sampling may be provided in the time domain, wherein the feedback for the serving communication channel is provided at time intervals of a certain time duration. In an embodiment, the feedback unit may be configured for providing feedback for communication channels which are not serving communication channels in time intervals that are of a second time duration which is in times, e.g. two times, the time duration of the intervals of the feedback for the serving communication channel.

According to a further embodiment, the granularity is obtained by scaling, i.e. by providing the granularity of a channel state information feedback component by scaling of a reference granularity. For example, in an embodiment the feedback unit is configured for setting the granularity of at least one of the first and channel state information feedback components by scaling i.e. by providing the granularity of the respective channel state information feedback component by scaling of a reference granularity. As mentioned above, the reference granularity may be the granularity of the feedback for the serving communication channel.

In a further embodiment relating to a cellular communication system, the feedback for the serving communication channel is a serving cell feedback and the feedback for a communication channel which is not a serving communication channel, is an inter-cell feedback.

According to an embodiment, the user equipment comprises a storage for storing at least two threshold ranges corresponding to different granularity levels for the feedback of the channel state information feedback component, and a range selector for selecting one of the different granularities the threshold range of which corresponds to the power indication signal. According to an embodiment, the at least two threshold ranges are stored together with the corresponding granularity level indicator. For example, a lookup table may be stored in the storage in which the at least two threshold ranges are associated with the corresponding granularity level indicators. According to an embodiment, the storage is a non-volatile storage. For example, the at least two threshold ranges and corresponding granularity level indicators may be fixedly predefined. According to another embodiment, the two threshold ranges and corresponding granularity level indicators are determined during operation of the user equipment. For example, according to an embodiment the at least two threshold ranges and corresponding granularity level indicators available for the user equipment are negotiated between the base station, to which the respective channel state information feedback component is provided, and the UE. Such negotiation may be performed by radial resource control (RRC) signalling.

According to a further embodiment, at least one of the channel state information feedback components, i.e. the first and/or the second channel state information feedback component, is provided by referring to a codebook entry of a codebook wherein each codebook entry corresponds to respective channel state, and wherein the user equipment further comprises a codebook selector configured for selecting a codebook out of a codebook set comprising at least two codebooks wherein each codebook corresponds to an associated level of granularity. By selecting a codebook corresponding to an associated level of granularity, a granularity in the spatial domain can be implemented.

According to a further embodiment, a communication channel (e.g. the non-serving communication channel or the serving communication channel) is established between a base station (non-serving base station or serving base station, respectively) and the user equipment via a cell provided by the respective base station.

According to a second aspect of the herein disclosed subject-matter, a base station of a cellular communication network is provided, the base station comprising a receiver unit configured for receiving from a user equipment channel state information feedback components on at least two different granularity levels.

This aspect of the herein disclosed subject-matter is based on the idea that with a respectively configured receiver in a base station of the wireless communication network the communication with a user equipment according to the first aspect or an embodiment thereof is possible.

According to an embodiment of the second aspect, the base station comprises a storage for storing at least two different threshold ranges corresponding to different granularity levels for the feedback of the channel state information feedback component, the threshold ranges being related to a signal strength with which a transmission is received by the user equipment. That is, in this embodiment, the threshold ranges already referenced with regard to an embodiment of the first aspect is defined in the storage of the base station in one embodiment. These threshold ranges defined in the base station may then be retrieved by or provided to the user equipment in order to set the threshold ranges in the user equipment and allow the user equipment to provide the channel state information feedback components depending on the power indication signal at a respective granularity level defined in the base station.

According to a further embodiment, the threshold ranges corresponding to different granularity levels are fixedly stored in the user equipment and are communicated to the base station by respective signalling, e.g. RRC signalling and are stored by the base station in its storage for further use.

According to an embodiment, the base station is configured so as to comprise corresponding features of embodiments defined with regard to the first aspect. For example, the type of granularity or details regarding the granularity described with regard to the first aspect or an embodiment thereof, may also be implemented in the base station.

According to a third aspect of the herein disclosed subject-matter, a method of operating a user equipment for a cellular communication network comprising a plurality of cells is provided, the method comprising receiving a first transmission via a first communication channel, the first communication channel using a first cell of the plurality of cells; receiving a second transmission via a second communication channel, the second communication channel using a second cell of the plurality of cells, wherein the second cell is different from the first cell;

providing a channel state information feedback component indicative of the state of the communication channel with a cell specific granularity.

Embodiments of the third aspect include performance of some or all of the actions described with regard to the first aspect or an embodiment thereof. Further embodiments of the third aspect include corresponding performance of some or all of the actions described with regard to the second aspect or an embodiment thereof.

According to a fourth aspect of the herein disclosed subject-matter, a method of operating a base station of a wireless communication network is provided, the method comprising receiving from a user equipment channel state information feedback components on at least two granularity levels.

According to embodiments of the fourth aspect, some or all of the actions and functions described with regard to the second aspect or, correspondingly described with regard to the first aspect, are implemented by respective embodiments of the method according to fourth aspect.

According to a fifth aspect of the herein disclosed subject-matter, a computer program is provided, the computer program being adapted for, when being executed by a data processor device, controlling the method as set forth with regard to the third aspect or an embodiment thereof.

According to a sixth aspect of the herein disclosed subject-matter, a computer program is provided, the computer program being adapted for, when being executed by a data processor device, controlling the method as set forth with regard to the fourth aspect or an embodiment thereof.

According to an embodiment, the data processor device includes one or more processors.

As used herein, reference to a computer program is intended to be equivalent to a reference to a program element and/or a computer-readable medium containing instructions for controlling a computer system to coordinate the performance of one or more of the above-described methods.

The computer program may be implemented as computer-readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network such as the WorldWideWeb, from which it may be downloaded.

Embodiments of the herein disclosed subject-matter may be realized by means of computer program, respectively software. However, embodiments of the herein disclosed subject-matter may also be realized by means of one or more specific electronic circuits, respectively hardware. Furthermore, embodiments of the herein disclosed subject-matter may also be realized in a hybrid form, i.e. in a combination of software modules and hardware modules.

In the above there have been described and in the following there will be described exemplary embodiments of the herein disclosed subject-matter with reference to a user equipment for a wireless communication network, a base station of a wireless communication network, a method of operating a user equipment for a wireless communication network and a method of operating a base station of a wireless communication network. It has to be pointed out that of course any combination of features relating to different aspects of the herein disclosed subject-matter is also possible. In particular, some embodiments have been described with reference to apparatus type claims whereas other embodiments have been described with reference to method type claims. However, a person skilled in the art will gather from the above and from the following description that, unless otherwise notified, in addition to any combinations of features belonging to one aspect also any combination of features relating to different aspects or embodiments, for example even between features of the apparatus type embodiments and features of the method type embodiments is considered to be disclosed with this application.

The aspects and embodiments defined above and further aspects and embodiments of the herein disclosed subject-matter are apparent from the examples to be described hereinafter and are explained with reference to the drawings but to which the invention is not limited.

### BRIEF DESCRIPTION OF THE DRAWINGS

FIG. 1 shows a cellular communication network in accordance with embodiments of the herein disclosed subject-matter.

FIG. 2 shows an exemplary definition of threshold ranges and corresponding granularity levels in accordance with embodiments of the herein disclosed subject-matter.

FIG. 3 shows sub-sampling in the time domain in accordance with embodiments of the herein disclosed subject-matter.

FIG. 4 shows scaling in the time domain in accordance with embodiments of the herein disclosed subject-matter.

FIG. 5 shows part of the cellular communication system of FIG. 1 in greater detail.

FIG. 6 shows an alternative implementation of the user equipment and a second base station in accordance with the herein disclosed subject matter.

### DETAILED DESCRIPTION

The illustration in the drawings is schematic. It is noted that in different figures, similar or identical elements are provided with the same reference signs or with reference signs which are different from the corresponding reference signs only within an appended character.

Embodiments of the herein disclosed subject-matter are applicable to cellular communication networks and in particular to coordinated multi-point transmission in cellular communication networks. However, the herein disclosed subject matter is not limited to such an application and the embodiments described with regard to a cellular communication system are well applicable to other wireless communication systems.

While explicit feedback, i.e. the eigenvector of the channel matrix, can provide the best picture of the channel state information, from a realistic system perspective, implicit feedback may be a better choice. From another perspective, independent cell-specific pre-coding matrix index (PMI) feedback is important since dynamic switch between coordinated multi-point transmission (CoMP) and single cell transmission may be a general requirement. Besides, inter-cell phase adjustment may be needed because the arrival signals from two cells might have a certain level of phase rotation with respect to each other.

Generally, the CSI information at the base station (eNodeB in the case of LTE advanced) can be summarized as:

F=[P₁^{H} A₂₁W_{2,1}^{H}P₂^{H} . . . AₖₗW_{k,l}^{H}Pₖ^{H}]^{H}

where P₁^{H} is the PMI feedback for a serving cell and Aₖₗ is the arrival signal strength ratio between cell k and the own cell 1. The arrival signal strength ratio Aₖₗ is usually smaller than 1 meaning that the signal strength of a transmission received from the own cell is higher than the signal strength of transmissions received from other cells. According to an embodiment, Aₖₗ is decided by the ratio of a longterm/wideband information, for example by the reference signal received power (RSRP). W_{k,l}^{H} is the phase/amplitude adjustment between cell k and the own cell 1. Finally, Pₖ^{H} is the PMI feedback for cell k. Since Pₗ^{H} is the PMI feedback for the serving cell, it is also referred to as serving cell feedback. According to an embodiment, the PMI feedback for the serving cell is the PMI feedback as defined in LTE release 10 (3GPP Project LTE advanced release 10 V 0.0.8 (2010-09)). Pₖ^{H} and W_{k,l}^{H} are intended to feedback the channel state information for neighbour cells and are therefore referred to as corresponding to inter-cell feedback.

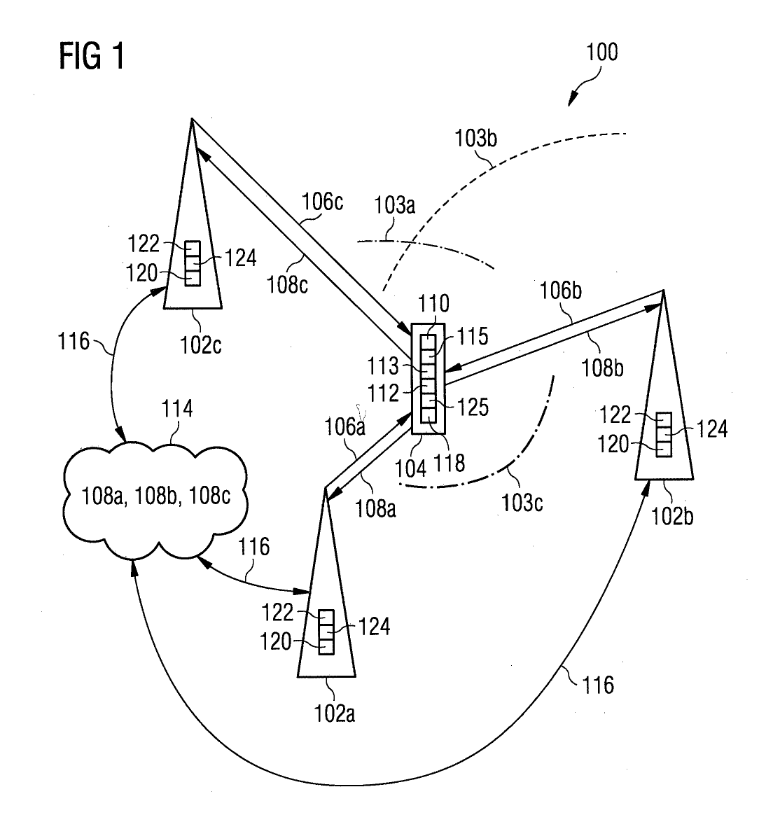

FIG. 1 shows a cellular communication network 100 in accordance with embodiments of the herein disclosed subject-matter. The cellular communication network 100 comprises a plurality of base stations, three of which are shown in FIG. 1 and indicated as 102a, 102b, 102c. A first base station 102a provides a first cell 103a, a second base station 102b provides a second cell 103b and a third base station 102c provides a third cell 103. The cells are only partially shown in FIG. 1 in order to not obscure the other elements of FIG. 1. Further shown in FIG. 1 is an user equipment 104 which is served by the first, serving base station 102a via a serving cell (cell 103a) provided by the serving base station 102a. The second base station 102b and the third base station 102c are non-serving base stations at the time instant considered in FIG. 1. It should be understood that usually each base station provides more than one cell and at least in some locations the user equipment 104 has access to two or more cells of a single base station. However, in order to simplify the illustration of embodiments of the herein disclosed subject matter, each cell 103a, 103b, 103c is shown as being provided by a separate base station. In other embodiments, not shown in FIG. 1, two or more of the described cells are provided by a single base station. However, the operation of such an amended configuration is analogue to the operation of the configuration shown in FIG. 1 and described in the following.

Depending on the location of the user equipment 104, the signal strength of respective transmissions 106a, 106b, 106c from the base stations 102a, 102b, 102c are usually quite different. Propagation loss can easily grant more than 10 dB difference on the signal strength of the received transmissions 106a, 106b, 106c. The inventors found that only around 20% of the user equipments can usually receive signals from two cells within a 3 dB window. In other words, most of the user equipments see transmissions from two cells with a relatively large strength difference; around 50% of the user equipments see signal strength differences greater than 10 dB. In particular, the arrival signal strength of transmissions 106a from the own cell 103a (provided by base station 102a) and of transmissions 106b, 106c from neighbour cells 103b, 103c (base stations 102b, 102c) are quite different. Thus normally Aₖₗ is quite small, e.g. below 0.1. However, this in turn means that the feedback from the corresponding cell k is less important. Consequently, using the same granularity for feedbacks from all the cells 103a, 103b, 103c of the cellular communication network 100 would result in an inappropriate use of feedback resources.

Feedback of channel state information from the user equipment 104 to the serving base station 102a is exemplarily indicated at 108a in FIG. 1. According to an embodiment, the user equipment 104 provides channel state information feedback components 108a, 108b, 108c for all cells 103a, 103b, 103c for which the user equipment 104 has calculated such channel state information feedback components. According to an embodiment, the user equipment 104 is configured for providing the channel state information feedback components 108a, 108b, 108c to the respective base station 102a, 102b, 102c, from which the transmission 106a, 106b, 106c has been received on the basis of which the channel state information feedback component 108a, 108b, 108c has been calculated.

In accordance with an embodiment, the user equipment 104 comprises a receiver unit 110 for receiving a transmission 106a from the serving base station 102a via a serving communication channel (not shown in FIG. 1). Further, the user equipment 104 comprises a feedback unit 112 configured for providing a serving channel state information feedback component 108a, indicative of the state of the serving communication channel (i.e. of the communication channel between the user equipment 104 and the first base station 102a).

Further, the feedback unit 112 is configured for providing a channel state information feedback component 108b indicative of the state of the communication channel between the user equipment 104 and the second base station 102b and a channel state information feedback component 108c indicative of the state of the communication channel between the user equipment 104 and the third base station 102c. The channel state information feedback component 108b is calculated by the feedback unit 112 of the user equipment 104 from the signal strength with which the transmission 106b is received by the receiver unit 110. Likewise, the channel state information feedback component 108c is calculated by the feedback unit 112 of the user equipment 104 from the signal strength with which the transmission 106c is received by the receiver unit 110 of the user equipment 104.

According to an embodiment shown in FIG. 1, the channel state information 108a, 108b, 108c is multicasted among neighbouring base stations, e.g. among base stations 102a, 102b, 102c. The multicasting of the channel state information feedback components 108a, 108b, 108c is indicated by the cloud 114 and the arrows 116.

In accordance with an embodiment, the receiver unit 110 provides power indication signals each indicative of the signal strength with which the respective transmission 106a, 106b, 106c has been received by the receiver unit 110. For example, in an embodiment, the power indication signal is provided by the receiver unit 110 and is further used by the feedback unit 112 of the user equipment 104.

In accordance with an embodiment, the feedback unit 112 is configured for providing the channel state information feedback components 108b, 108c of the non-serving communication channels with a granularity that depends on the power indication signal. Further in accordance with an embodiment, the feedback unit 112 is configured for providing the channel state information feedback component 108a of the serving communication channel independent of the signal strength with which the transmission 106a from the serving base station 102a is received by the receiver unit 110.

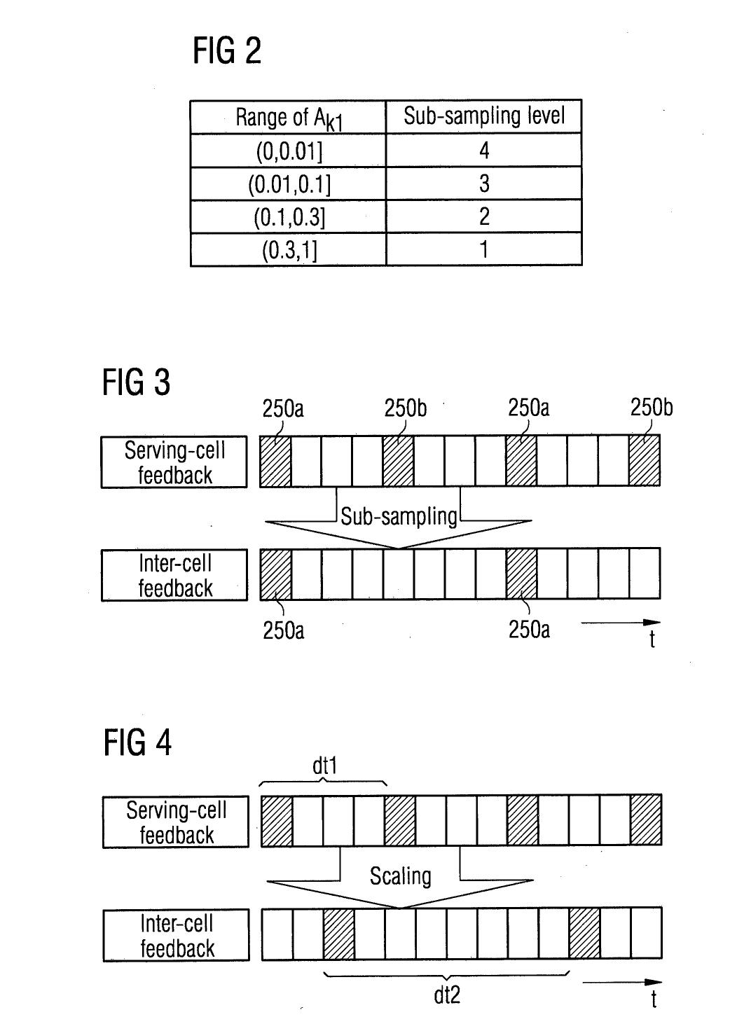

In accordance with an embodiment, the different granularity is provided by adaptive sub-sampling for an inter-cell PMI feedback. To this end, two steps are taken: First, different components (e.g. the channel state information feedback components) of the CoMP report can be reported with different granularity in time and/or frequency and/or space. Second, the feedback granularity for different feedback components is based on the reference signal received power (RSRP) report of the user equipment. Considering that each feedback component 108b, 108c is weighted by Aₖₗ (e.g. decided by the reported RSRP), the sub-sampling level to the respective cell 103b, 103c should also be, in an embodiment, dependent on Aₖₗ. To this end, a table of threshold ranges is negotiated between the respective base station 102b, 102c and the user equipment 104, e.g. through RRC signalling. According to other embodiments, the table of threshold ranges is fixedly specified in the communication specification implemented in the user equipment 104 and the base stations 102a, 102b, 102c. An example of a table of threshold ranges and corresponding granularity levels is shown in FIG. 2, wherein the first column specifies the ranges of Aₖₗ for the respective sub-sampling level which is given in the second column.

In accordance with an embodiment, the feedback unit 112 comprises a range selector 113 for selecting one of the different granularities the threshold range of which corresponds to the power indication signal.

Since in an embodiment the Aid is also reported from the user equipment 104 to the respective base station 102b, 102c, it is reasonable to assume that the base stations 102b, 102c and the user equipment 104 are synchronized with Aₖₗ and therefore also with the actual granularity to be used. Hence the contents of the table shown in FIG. 2 and the actually selected entry thereof is known at both the base station and the user equipment side. In an embodiment, the definition of the sub-sampling level specified in column 2 of FIG. 2, is the ratio of the serving cell feedback 108a and the intercell feedback 108b, 108c. The sub-sampling level can be integrated in different domains, for example in the time domain, in the frequency domain, in the spatial domain or in a hybrid domain including a combination of two or more of the aforementioned domains, for example in a combined time domain and spatial domain.

In the following, an example of time domain sub-sampling is given.

When the user equipment 104 sends a feedback component 108a, 108b, 108c, the ratio of the own cell feedback and the inter-cell feedback follows the threshold ranges defined in the user equipment 104.

It should be mentioned, that the user equipment 104 may comprise a storage 118 for storing the at least two threshold ranges, for example the four threshold ranges of FIG. 2 corresponding to the respective, different granularity levels for the feedback of the channel state information feedback components.

In accordance with embodiments of the herein disclosed subject-matter, the base stations 102a, 102b, 102c comprise a receiver unit 120 configured for receiving from the user equipment 104 channel state information feedback components 108a, 108b, 108c, respectively on at least two different granularity levels. At a specific instant the base stations 102a, 102b, 102c receive from a particular user equipment 104 channel state information feedback components only on one particular granularity level depending on the respective power indication signal generated by the receiver unit 110 of the user equipment 104. However, the base stations 102a, 102b, 102c are nonetheless capable of receiving the channel state information feedback components on all the different granularity levels, e.g. on the granularity levels as specified in FIG. 2, since the granularity level may change with time (in accordance with the change of the state of the communication channel).

In accordance with an embodiment, the base stations 102a, 102b, 102c may comprise a storage 122 for storing at least two threshold ranges corresponding to different granularity levels for the feedback of the channel state information feedback component, e.g. as specified in FIG. 2. The number of threshold ranges supported by the base station may vary among different base stations. The base stations may further include a control unit 124. In an embodiment, the control unit 124 includes a processor device for carrying out a computer program implementing one or more of the herein described units and entities of the base station.

In case of periodical physical uplink control channel (PUCCH) feedback, a new type of feedback is defined to transmit inter-cell PMI Pₖ^{H} and phase/amplitude adjustor W_{k,l}^{H}. The duty cycle (i.e. the periodicity) of Pₖ^{H} and W_{k,l}^{H} is N times of serving cell PMI where N is the sub-sampling level. This is shown in FIG. 3. Accordingly, FIG. 3 shows an example of sub-sampling in accordance with embodiments of the herein disclosed subject matter. In FIG. 3 a full (black) rectangles 250a, 250b indicate a transmission of feedback occuring at specific instances in time t. In the exemplary embodiment of FIG. 3, the sub-sampling level is 2, i.e. the inter-cell feedback misses every second feedback transmission 250b and hence only the feedback transmissions 250a are taken into account for inter-cell feedback.

In case of aperiodical physical uplink shared channel (PUSCH) feedback, two methods can be applied:

First method: One additional bit is imbedded in DCI-0/4 to trigger the inter-cell PMI+phase/amplitude adjustor. Then the base station can control transmitting density for serving cell feedback and inter-cell feedback separately. (there is already one bit there to trigger serving cell PMI feedback, which is called “channel quality indication (CQI) request” bit in 3GPP TS 36.212 V9.3.0 (2010-09). According to an embodiment, the base station will control the ratio between serving cell feedback and inter-cell feedback following the table in FIG. 2

Second method: Implicit rules: As UE knows the sub-sampling level for inter-cell PMI feedback, it can alternatively transmit serving-cell feedback and inter-cell feedback responding the CQI request bit triggering.

### Frequency Domain Sub-Sampling

If feedback is configured to have frequency selective PMI, the granularity of inter-cell PMI is N times of serving-cell's PMI. For example, in 10 Mhz, serving-cell PMI feedback subband is three physical resource blocks (PRBs), inter-cell PMI subband is N*3 subband. According to an embodiment, N is the sub-sampling level in FIG. 2. Also, the granularity phase/amplitude adjustor W_{k,l}^{H} could be N times of serving-cell PMI.

Spatial Domain Sub-Sampling

Current LTE Rel.10 design provides a codebook for serving-cell PMI feedback (Pₗ^{H}) under different Tx antenna number cases. For example, a 4 states codebook (2 bits PMI feedback) is required for 2 Tx antennas and a 16 states (4 bits PMI feedback) codebook is required for 4 Tx antennas. In LTE Re1.10, it was proposed to have codebook sub-sampling on the 8 Tx codebook, (R1-105326: 3GPP TSG-RAN WG1 #62bis Xi'an, China, Oct. 11-Oct. 15, 2010). Similar sub-sampling method can be applied to inter-cell PMI codebook as well.

Further, in an embodiment it is assumed that a serving-cell PMI codebook requires M bits feedback. The codebook size for inter-cell PMI (in bits) should be sub-sampled to M-N bits.

One example is that under 4 Tx antennas, a serving-cell PMI Pₗ^{H} needs a 4 bit codebook for quantification, then the code-book for inter-cell PMI Pis a subset of the serving-cell codebook and only needs 4-N bits for feedback.

Similar to Pₖ^{H}, the codebook for phase/amplitude adjustor W_{K,l}^{H} could be sub-sampled if needed based on the sub-sampling level using the same principle.

In accordance with an embodiment, a set of codebooks is provided, of which each codebook corresponds to specific granularity. Further, a codebook selector 115 configured for selecting a codebook out of a codebook set comprising at least two codebooks is provided, wherein each codebook corresponds to an associated level of granularity.

In accordance with an embodiment, the user equipment 104 comprises a control unit 125 for controlling one or more functions of the user equipment 104. In accordance with embodiments not shown in FIG. 1, the control unit 125 of the user equipment 104 implements the function of one or more of the specific units and entities described herein with regard to the user equipment. In accordance with a further embodiment, the control unit 125 comprises a processor device for carrying out a computer program in order to provide the respective functions implemented in the computer program.

### Hybrid Sub-Sampling

An examble is e.g. a combination of a time domain and a spatial domain: sub-sampling can be done in both domains. For example, the sub-sampling level is 3, then time domain sub-sampling level could be 2 and spatial domain sub-sampling level is 1.

### Adaptive Scaling

In order to implement the different granularity for different ranges of Aₖₗ, e.g. according to FIG. 2, one alternative method following this adaptive principle is “scaling” instead of “sub-sampling”. The difference is that sub-sampling only allows the feedback of inter-cells as a subset of serving cell's, while scaling means an independent configuration is allowed for inter-cell feedback, only the overhead is in a fixed ratio to serving-cell feedback see FIG. 4. In particular the time interval (periodicy) dt1 of the serving cell feedback is scaled (multiplied) with a scaling factor resuling in a respectively scaled inter-cell feedback with a scaled time interval (perodicy) dt2. Technical speaking, sub-sampling is a one special case of scaling. Following the above description, time, frequency, and spatial domain feedback sets or hybrid feedback sets can be configurated for scaling:

### 1. Time Domain

According to an embodiment, the duty cycle of inter-cell feedback is N times of serving cell's, N is decided by the scaling level from FIG. 2, but inter-cell feedback can be independently configured (scaling level is the same to sub-sampling level).

2. Frequency Domain

The subband size for inter-cell feedback is decided by the scaling level (following FIG. 2). But the starting position of subband for inter-cell feedback could be independently configured.

### 3.Spatial Domain:

Different codebook sets are defined to support different inter-cell PMI feedback accuracy (granularity). Codebook size is decided by the scaling level, which may not be a subset of serving cell codebook.

Of course, scaling level can be configured jointly in time domain, frequency domain or spatial domain similar as sub-sampling.

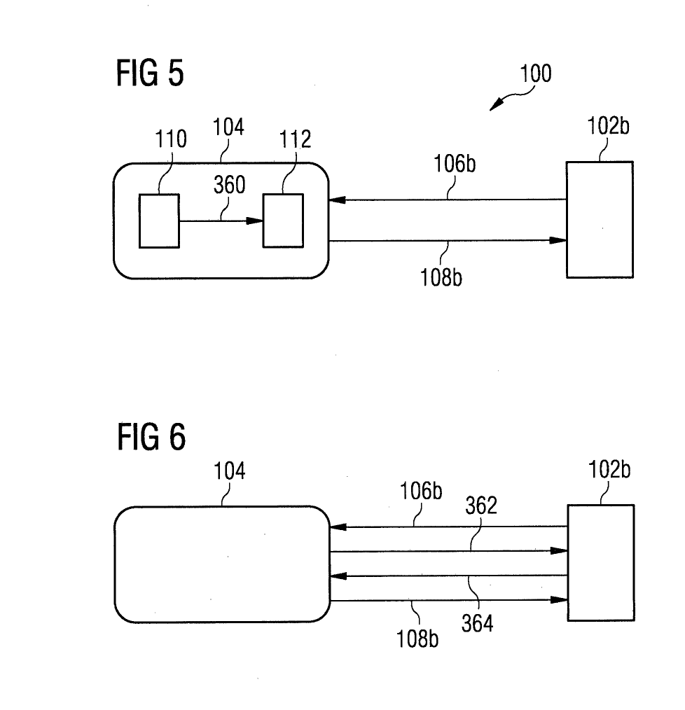

FIG. 5 shows part of the cellular communication system 100 of FIG. 1 in greater detail. As shown in FIG. 5, the receiver unit 110 of the user equipment 104 receives the transmission 106b from the base station 102b (the cell 103b of FIG. 1 is not shown in FIG. 5. In response hereto, the receiver unit 110 provides a power indication signal 360 indicative of a signal strength with which the second transmission 106b is received by the receiver unit 110. In accordance with an embodiment, the power indication signal 360 is provided to the feedback unit 112. In response to receiving the power indication signal 360, the feedback unit providing the second channel state information feedback component 108b to the second base station 102b with a granularity that depends on the power indication signal 360.

FIG. 6 shows an alternative implementation of the user equipment 104 and a second base station 102b in accordance with the herein disclosed subject matter. In this implementation, upon reception of a transmission 106b from the base station 102b, the user equipment provides an information signal 362 back to the base station 102b. In an embodiment, the information signal 362 may be indicative of the signal strength with which the transmission 106b is received by the user equipment (or its receiver unit, not shown in FIG. 6). In response to the information signal 362, the base station 102 provides a granularity indicating signal 364 to the user equipment, the granularity indicating signal 364 setting the cell specific granularity of the channel state information feedback component 108b which is to be transmitted to the base station 102b. The cell specific granularity may be stored in a storage (not shown in FIG. 6) of the user equipment 104. In response to the granularity indicating signal 364, the user equipment provides the channel state information feedback component 108b with the granularity as defined by the granularity indicating signal 364.

Further, although some embodiments refer to a “base station” or “eNB”, etc., it should be understood that each of these references is considered to implicitly disclose a respective reference to the general term “network access node”. Also other terms which relate to specific, standards or specific communication techniques are considered to implicitly disclose the respective general term with the desired functionality.

It should further be noted that a network entity or a network node as disclosed herein are not limited to dedicated entities as described in some embodiments. Rather, the herein disclosed subject matter may be implemented in various ways in various locations in the communication network while still providing the desired functionality.

According to embodiments of the invention, any component of the wireless communication system, e.g. the units and entities 110, 112, 113, 118 of the user equipment or the units and entities 120, 122 of the base stations described are provided in the form of respective computer program products which enable a processor to provide the functionality of the respective elements as disclosed herein. According to other embodiments, any component of the wireless communication system, e.g. the units of the user equipment or the units of the base stations described herein may be provided in hardware. According to other—mixed—embodiments, some components may be provided in software while other components are provided in hardware. Further, it should be noted that a separate component (e.g. module) may be provided for each of the functions disclosed herein. According to other embodiments, at least one component (e.g. a module) is configured for providing two or more functions as disclosed herein.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state:

It is described a user equipment for a cellular communication network providing a plurality of cells, the user equipment comprising: a receiver unit for receiving a first and second transmissions via a first and a second communication channel.

The first communication channel uses a first cell and the second communication channel uses a different, second cell of said plurality of cells. A feedback unit is configured for providing a first and second channel state information feedback components for the respective communication channels with a separate, cell specific granularity. Further described is a base station of the cellular communication network.

### LIST OF REFERENCE SIGNS

100 cellular communication network
102a serving base station
102b non-serving base station
102c non-serving base station
103a cell provided by 102a
103b cell provided by 102b
103c cell provided by 102c
104 user equipment
106a transmission from 102a
106b transmission from 102b
106c transmission from 102c
108 channel state information
108a,108b,108c channel state information feedback components
110 receiver unit
112 feedback unit
113 range selector
114 cloud
115 codebook selector
116 arrows indicating multicasting of channel state information components
118 storage
120 receiver unit of 102a, 102b, 102c, respectively
122 storage
124 control unit of 102a, 102b, 102c
125 control unit of 104
250a, 250b feedback transmission occurence
360 power indication signal
362 information signal
364 granularity indicating signal
dt1 time interval for serving cell feedback
dt2 time interval for inter-cell feedback
t time

1. User equipment for a cellular communication network providing a plurality of cells, the user equipment comprising:
a receiver unit for receiving a first transmission via a first communication channel and for receiving a second transmission via a second communication channel, the first communication channel using a first cell of said plurality of cells and the second communication channel using a second cell of said plurality of cells, the second cell being different from the first cell;
a feedback unit configured for providing a first channel state information feedback component indicative of the state of the first communication channel and a second channel state information feedback component indicative of the state of the second communication channel;
the feedback unit being further configured for providing each of the first channel state information feedback component and the second channel state information feedback component with a separate, cell specific granularity.

2. User equipment according to claim 1,
wherein the first channel state information feedback component is provided with a first granularity and the second channel state information feedback components is provided with a second granularity that is more coarse than the first granularity.

3. User equipment according to claim 1,
wherein the receiver unit is configured for receiving a granularity indicating signal from a base station of the cellular communication network, the granularity indicating signal setting the cell specific granularity of at least one of the first channel state information feedback component and the second channel state information feedback component.

4. User equipment according to one of the preceding claims claim 1,
the receiver unit being configured for providing a power indication signal indicative of a signal strength with which the second transmission is received by the receiver unit
the feedback unit being configured for providing the second channel state information feedback component with a granularity that depends on the power indication signal.

5. User equipment according to claim 1,
wherein the cell specific granularity is a granularity in at least one of time, frequency, space.

6. User equipment according to claim 1,
wherein the feedback unit is configured for setting the cell specific granularity of at least one of the first and second channel state information feedback components by sub-sampling, i.e. by providing the granularity of the respective channel state information feedback component as a subset of a reference granularity.

7. User equipment according to claim 1,
wherein the feedback unit is configured for setting the granularity of at least one of the first and second channel state information components by scaling, i.e. by providing the granularity of the respective channel state information feedback component by scaling of a reference granularity.

8. User equipment according to claim 4, further comprising
a storage for storing a at least two threshold ranges corresponding to different granularity levels for the feedback of the channel state information feedback component;
a range selector for selecting one of the different granularities the threshold range of which corresponds to the power indication signal.

9. User equipment according to claim 1,
wherein at least one of the first and second channel state information feedback components is provided by referring to a codebook entry of a code-book, wherein each codebook entry corresponds to a respective channel state;
the user equipment further comprising a codebook selector configured for selecting a codebook out of a codebook set comprising at least two codebooks, wherein each codebook corresponds to an associated level of granularity of the respective channel state information feedback component.

10. Base station of a cellular communication network, the base station comprising:
a receiver unit configured for receiving from a user equipment channel state information feedback components on at least two different granularity levels.

11. Base station according to claim 10, further comprising:
a storage for storing at least two threshold ranges corresponding to different granularity levels for the feedback of the channel state information feedback components, the threshold ranges being related to a signal strength with which a transmission is received by the user equipment.

12. Method of operating user equipment for a cellular communication network providing a plurality of cells, the method comprising:
receiving a first transmission via a first communication channel, the first communication channel using a first cell of the plurality of cells;
receiving a second transmission via a second communication channel, the second communication channel using a second cell of the plurality of cells, wherein the second cell is different from the first cell;
providing a channel state information feedback component indicative of the state of the communication channel with a cell specific granularity.

13. Method of operating a base station of a wireless communication network, the method comprising:
receiving from a user equipment channel state information feedback components on at least two different granularity levels.

14. Computer program being adapted for, when being executed by a data processor device, controlling the method as set forth in claim 12.

15. Computer program being adapted for, when being executed by a data processor device, controlling the method as set forth in claim 13.
